(19) United States
(12) Patent Application Publication
(10) Pub. No.: US 2010/0054505 A1
(43) Pub. Date: Mar. 4, 2010

(54) FILM SPEAKER

(75) Inventors: ZHI-GANG ZOU, Shenzhen City (CN); GUO-LIANG HU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/342,922

(22) Filed: Dec. 23, 2008

(30) Foreign Application Priority Data
Aug. 28, 2008 (CN) 200810304278.2

(51) Int. Cl. H04R 17/00

(52) U.S. Cl. 381/190

(57) ABSTRACT

A film speaker includes at least one connecting pole, at least one piezoelectric film forming an empty cavity and an conductive layer coated on the piezoelectric film. The connecting pole is electrically connected to the conductive layer.

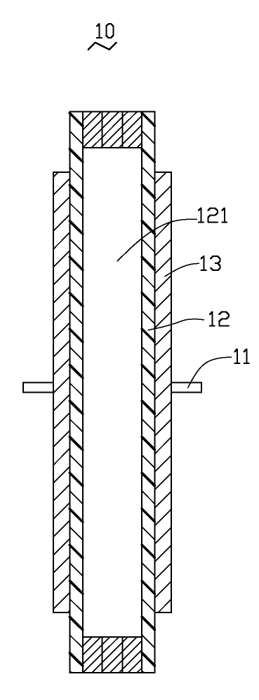

### BACKGROUND

1. Technical Field

The present disclosure relates to a speaker, and particularly, to a film speaker.

2. Description of Related Art

A conventional speaker has a tapered body section defining a resonant space. However, because speakers are usually heavy and inconvenient to carry, film speakers have been developed for use in portable electronic devices (e.g., mobile phones).

A film speaker typically uses a piezoelectric film. The piezoelectric film vibrates when electrified to produce sound. However, film speakers usually require a relatively large space to vibrate in, causing the portable electronic device to have to be made larger.

Therefore, there is room for improvement within the art.

### BRIEF DESCRIPTION OF THE FIGURE

Many aspects of the film speaker can be better understood with reference to the following drawing. The drawing is not necessarily drawn to scale, the emphasis instead being placed upon clearly illustrating the principles of the present film speaker.

The FIGURE is a cross-sectional view of a film speaker, according to an exemplary embodiment.

### DETAILED DESCRIPTION OF EXEMPLARY EMBODIMENT

The FIGURE shows an exemplary embodiment of a film speaker 10. The film speaker 10 may include two connecting poles 11, two piezoelectric films 12, and two conductive layers 13.

One end of each connecting pole 11 is electrically connected to one of the piezoelectric films 12, and the other end of each connecting pole 11 is electrically connected to a driving circuit (not shown) for driving (i.e., electrifying) the film speaker 10.

The piezoelectric films 12 are made of polyvinylidene fluoride. The two piezoelectric films 12 may be adhered together at their edges and enclose a cavity 121. Alternatively, one film 12 could be used and folded over on itself and glued at its free edges to form the cavity 121. The cavity 121 allows the piezoelectric films 12 enough air space to vibrate to create sound and to resonate to improve sound quality.

The conductive layers 13 are made of an electrically conductive material (e.g., metal). Exposed surfaces of the piezoelectric films 12 are coated with the conductive layers 13 to electrically connect the connecting poles 11 with the piezoelectric films 12.

The cavity 121 of the film speaker 10 reduces a space required for vibration of the piezoelectric films 12, thereby allowing a smaller electronic device that can utilize the film speaker 10.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of sections within the principles of the invention to the full extent indicated by the broad general meaning of the terms, in which the appended claims are expressed.

What is claimed is:

1. A film speaker, comprising:
at least one connecting pole;
at least one piezoelectric film forming a cavity; and
a conductive layer coated to the piezoelectric film, the connecting pole being electrically connected to the conductive layer.

2. The film speaker as claimed in claim 1, wherein there are two piezoelectric films and edges of the two piezoelectric films adhere with each other to form the cavity.

3. The film speaker as claimed in claim 1, wherein the cavity is formed by edges of the piezoelectric film adhering with each other.

4. The film speaker as claimed in claim 1, wherein the piezoelectric film is made from polyvinylidene fluoride.
